(19) United States
(12) Patent Application Publication
(10) Pub. No.: US 2011/0299400 A1
(43) Pub. Date: Dec. 8, 2011

(54) System for congestion control in packet networks

(75) Inventors: Aaron E. Cohen, White Bear Lake, MN (US); Keshab K. Parhi, Maple Grove, MN (US)

(73) Assignee: Leanics Corporation

(21) Appl. No.: 12/802,271

(22) Filed: Jun. 4, 2010

(51) Int. Cl. H04L 12/26

(52) U.S. Cl. 370/237

(57) ABSTRACT

Variable Rate Congestion Controllers and methods for implementing Variable Rate Congestion Control are presented. An efficient and systematic method for performing variable rate network congestion control is presented. A selection mechanism is selected such that the end result for the network congestion control is that each variable rate network flow suffers approximately equally through the congested node. This achieves a fair policy of implementing Quality of Service for variable rate streaming data.

### CROSS-REFERENCE TO RELATED APPLICATIONS

This application claims the benefit of the U.S. Provisional Application No. 61/217,695 filed Jun. 3, 2010, which is incorporated herein by reference in its entirety.

### STATEMENT REGARDING FEDERALLY-SPONSORED RESEARCH AND DEVELOPMENT

This invention was made with Government support from the Navy under Contract No. N00039-06-C-0096, SBIR Phase I: Tactical Secure Voice/Variable Data Rate Inter Working Function.

### FIELD OF THE INVENTION

The present invention relates to data processing, transmission, networking, and digital communication. More specifically, it is related to quality of service of voice over Internet protocol.

### BACKGROUND OF THE INVENTION

Variable data rate communication is relatively new for sensor technology and voice communication. Until recently the majority of communication systems were designed for fixed bandwidth applications. Migrating to modern variable data rate communication systems has improved signal-to-noise ratio (SNR) of signals, Mean Opinion Score (MOS), decreased the outage probability, and increased the channel capacity of the communication links and networks.

Sensor networks are becoming common place with the decreasing cost and power requirements. These networks allow multiple types of information to be transmitted at various transmission rates. Newer systems allow feedback that can increase the efficiency of the system. One example might be to make more efficient use of water resources by decreasing water runoff through smart watering systems which protect from over-watering and under-watering.

Variable data rate voice compression technology is dominated by several techniques. The first technique relies on voice activity detection (VAD) and is employed in modern day cellular and voice over Internet protocol (VoIP) systems. The main voice compression CODECs used in modern systems are the adaptive multi-rate (AMR) codec for GSM, the EVRC-B codec from Qualcomm for 1xEVDO, and Speex for open source VoIP applications (3GPP TS 26.104: ANSI-C code for the floating-point Adaptive Multi-Rate (AMR) speech codec, 3GPP2 TSG-C C.R0018-C v1.0: Software Distribution for Enhanced Variable Rate Codec (EVRC), Speech Service Options 3, 68, and 70, Minimum Performance Specification 1/2008, Speex: a free codec for free). AMR implements a discontinuous transmission method to achieve variable rate transmission. Additional rate adjustments must be made prior to using the encoder. The EVRC-B code achieves variable rate transmission by using a discontinuous transmission method like the AMR codec. The Speex codec uses a different approach to achieve variable rate transmission. Speex bases its quantization on the actual speech which allows it to achieve better performance in variable data rate (VDR) applications. In the new ITU-T standard G.729.1, a scalable variable data rate codec is described that is compatible with G.729 but can assist in Quality of Service through adaptive bit rates after transmission at intermediate nodes (S. Ragot, et al., “ITU-T G.729.1: An 8-32 kbit/w scalable coder interoperable with G.729 for wideband telephony and voice over IP,” in Proceedings of the IEEE International Conference on Acoustics, Speech, and Signal Processing, vol. 4, pp. 529-532, Apr. 15-20, 2007).

The primary challenge with implementing efficient Voice over Internet protocol (VoIP) implementations is Quality of Service (QoS). Traditional techniques for enhancing Quality of Service (QoS) at the transmitter side relied on implementing rate adaptation, sending multiple audio frames per packet, interleaving multiple frames between packets, and improved CODEC compression technology. Traditional techniques for enhancing Quality of Service (QoS) at the receiver side relied on implementing Jitter Buffers, audio frame reordering for interleaved packets, and Packet Loss Concealment (PLC) technology.

The present invention focuses on improving Quality of Service (QoS) during network congestion by solving the problem of how to handle network congestion at intermediate nodes when using variable rate data. While there exist many ways to enhance QoS in VoIP networks and other digital communication systems, additional gains in QoS can be achieved if intermediate congested nodes are allowed to take action to prevent packet loss. What is needed is a systematic method for implementing QoS enhancements at intermediate congested nodes that reduces packet loss.

### BRIEF SUMMARY OF THE INVENTION

The present invention provides an efficient implementation of enhancing Quality of Service (QoS) in digital communication at intermediate nodes and describes a method for efficiently implementing the QoS enhancement techniques at intermediate nodes. This method implements a lossy transmission technique designed for signals and systems which are tolerant to noise. In this manner, this method maximizes the received quality of data.

In accordance with the present invention, the variable rate digital audio representation consists of data which is highly important and data which is less important but enhances quality. An example is the problem of speech reconstruction using variable rate encoders. These variable rate encoders separate the speech into high priority low frequency data and lower priority high frequency data. The high frequency data enhances the quality of the speech reconstruction. Another example is for multi-frame packets with packet loss concealment (PLC) for speech reconstruction on the receiver side. The high priority data are the frames which are farthest apart in the same packet and between packets. In other examples, other methods for determining priorities may be used. The network congestion method will take the variable priority into account in determining which data to transmit during highly congested times and which data can be dropped. If known, it will take into account the receiver's capabilities such as Packet Loss Concealment (PLC) to determine which audio frames can be dropped to minimize the audio frame gap duration due to lost audio frames through the use of PLC.

Further embodiments, features, and advantages of the present invention, along with structure and operation of various embodiments of the present invention, are discussed in detail below with reference to the accompanying figures.

### BRIEF DESCRIPTION OF THE DRAWINGS/FIGURES

The present invention is described with reference to the accompanying figures. In the figures, like reference numbers indicate identical or functionally similar elements. Additionally, the left-most digit or digits of a reference number identify the figure in which the reference number first appears. The accompanying figures, which are incorporated herein and form part of the specification, illustrate the present invention and, together with the description, further serve to explain the principles of the invention and to enable a person skilled in the relevant art to make and use the invention.

FIG. 1. illustrates a Congested Link in a Network.

FIG. 2. illustrates the Network Congestion Router Model.

FIG. 3. illustrates the Baseline Random (RND) Decision Criteria flow chart.

FIG. 4. illustrates the Frequency (FRQ) Decision Criteria flow chart.

FIG. 5. illustrates the Combined Random Frequency (CRFRQ) Decision Criteria flow chart.

FIG. 6. illustrates the Combined Frequency Random (CFRND) Decision Criteria flow chart.

FIG. 7. illustrates the variant random frequency (VRF) Decision Criteria flow chart.

FIG. 8. illustrates a comparison of the 4 main decision criteria flow charts.

FIG. 9. illustrates the Setting Priorities for Variable Rate Data Method.

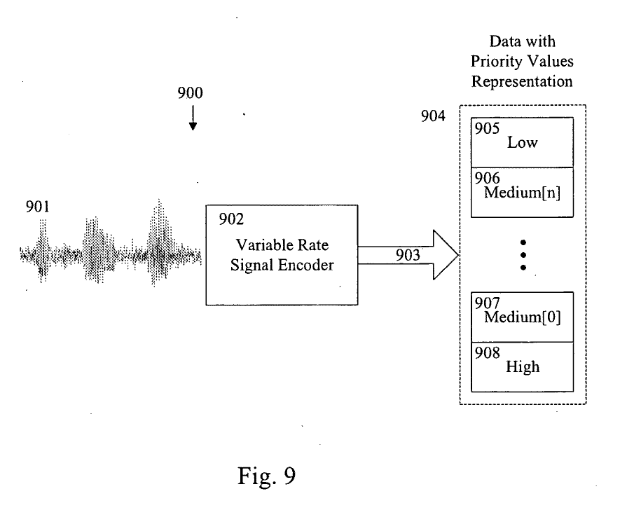

FIG. 10. illustrates the Setting Priorities for Multi-Frame Packet Method.

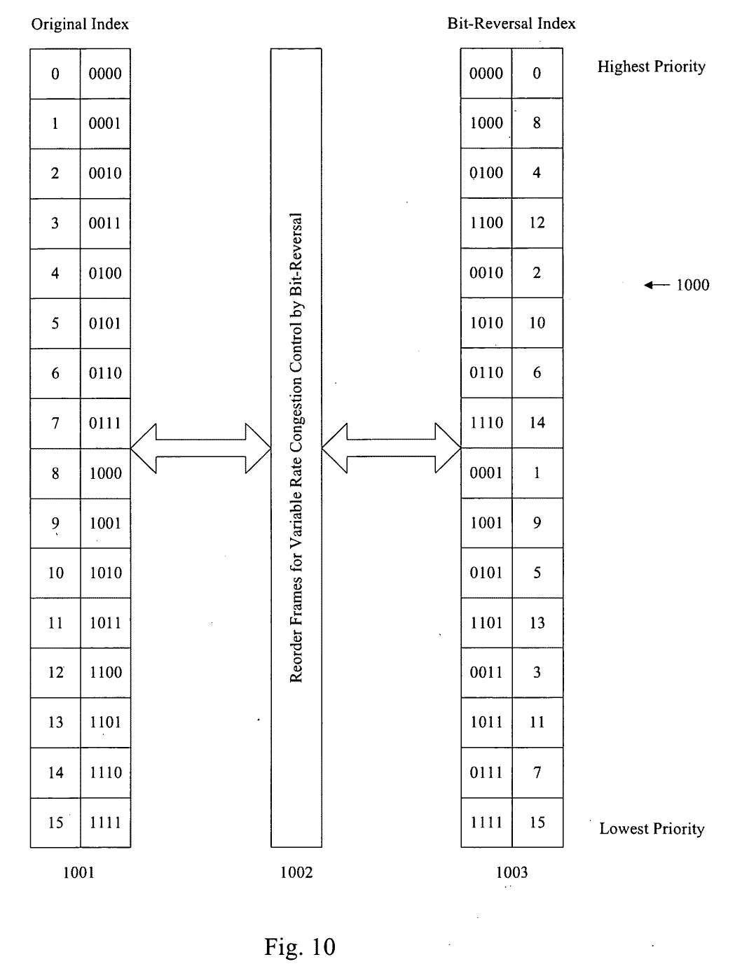

### DETAILED DESCRIPTION OF THE INVENTION

Modern digital communication networks consist of sources (transmitters), destinations (receivers), and routers. Transmitters (or sources) generate packets and put them on the network. Receivers receive packets sent from transmitters and consume the packets by taking them off the network. Routers are intelligent systems which aid the packets in moving from transmitter to receiver and together with sources and destinations form the network. Packets can consist of multiple types of information. For this invention, packets which consist of variable data rate information will be considered. Specifically, variable data rate packets that contain an audio frame generated by a variable data rate voice encoder or multiple audio frames generated by a fixed length voice encoder but reordered in such a way as to mimic variable data rate frames. Each variable data rate audio frame consists of data of varying priority levels. Each multiple audio frame packet consists of data of varying priority levels. These priority levels will be used to decrease the effects of network congestion on received data. Specifically, when properly implemented, this will improve the received signal quality of speech, video, and other signals.

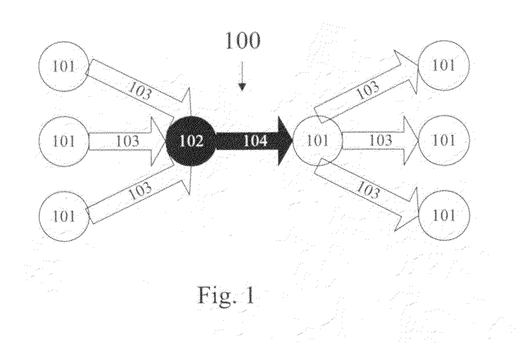

Modern digital communication networks suffer from network congestion. Network congestion occurs when one link in the network has reached its transmission capacity and all subsequent packets through the congested link are delayed or lost. FIG. 1 illustrates circuit 100 a congested link in a network.

Circuit 100 consists of blocks 101, 102, 103, and 104. Block 101 is a standard node in the network. In an embodiment, block 101 is a network router. In another embodiment, block 101 is a network gateway. In another embodiment, block 101 is a networked computer. In another embodiment, block 101 is a networked sensor. In other embodiments, other networked devices may be used. Block 102 is a congested node in the network. In an embodiment, block 102 is a network router. In another embodiment, block 102 is a network gateway. In another embodiment, block 102 is a networked computer. In another embodiment, block 102 is a networked sensor. In other embodiments, other networked devices may be used. Block 103 is a standard directional link in the network. In an embodiment, block 103 is an Ethernet over Copper Cable link. In another embodiment, block 103 is a Fiber Optic link. In another embodiment, block 103 is a wireless link. In other embodiments, other links may be used. Block 104 is a congested link in a network. In an embodiment, block 104 is an Ethernet over Copper Cable link. In another embodiment, block 104 is a Fiber Optic link. In another embodiment, block 104 is a wireless link. In other embodiments, other links may be used.

Circuit 100 consists of source nodes which transmit data and destination nodes which receive data. This data flows from source to destination through intermediate nodes. The intermediate nodes often become congested when multiple sources are transmitting data at the same time.

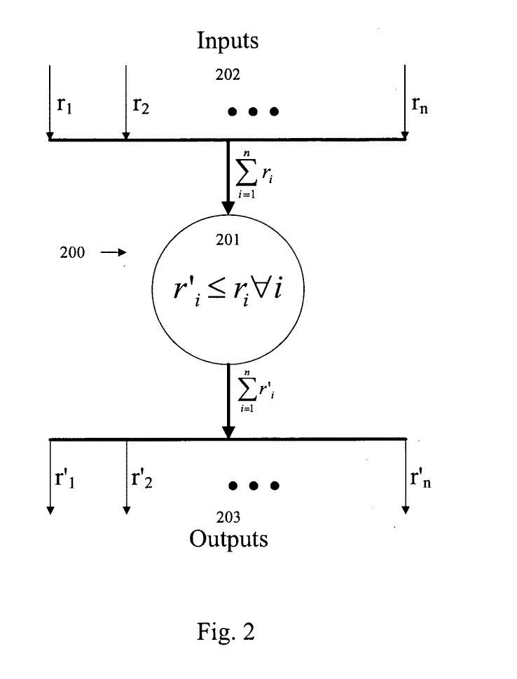

The black congested node 102 in Circuit 100 must make a decision on what information to transmit over the black congested link 104. In a typical implementation the black congested node will attempt to transmit everything it has received and will only drop packets when its buffer(s) is (are) full. Due to the time critical nature of VoIP traffic, to improve Quality of Service (QoS) at congested nodes, the black congested node 102 can dynamically adjust the amount of information it transmits during a given time period based on its link capacity illustrated in FIG. 2. Circuit 200 in FIG. 2 illustrates a network congestion router model.

Circuit 200 consists of blocks 201, 202, and 203. Block 201 is a node in the network. In an embodiment block 201 is a network router. In another embodiment, block 201 is a network gateway. In another embodiment, block 201 is a networked computer. In another embodiment, block 201 is a networked sensor. In other embodiments, other networked devices may be used. Block 202 illustrates the input links. In an embodiment, block 202 consists of an array of Ethernet over Copper Cable links. In another embodiment, block 202 consists of an array of Fiber Optic links. In another embodiment, block 202 consists of an array of wireless links. In other embodiments, other links and combination of links may be used. Block 203 is the output links. In an embodiment, block 203 consists of an array of Ethernet over Copper Cable links. In another embodiment, block 203 consists of an array of Fiber Optic links. In another embodiment, block 203 consists of an array of wireless links. In other embodiments, other links and combination of links may be used.

Circuit 200, the network congestion router model, is able to increase Quality of Service (QoS) for networked applications through intelligent network congestion handling. Each input link contains rᵢ units of data such that the total units of data which must be processed is

$${\sum }_{i = 1}^{n} {r}_{i} .$$

The capacity of the output links may or may not be less than this total value. If the capacity exceeds the total units of data then transmission occurs without congestion. If the total units of data exceed the capacity then congestion occurs and the intelligent network router will perform an intelligent method to reduce the total units of data to or below the capacity.

There are primarily four policies governing QoS which are proposed next: baseline random (RND), frequency (FRQ), combined random frequency (CRFRQ), and combined frequency random (CFRND). There is an additional method called variant random frequency (VRF) which will be illustrated afterwards.

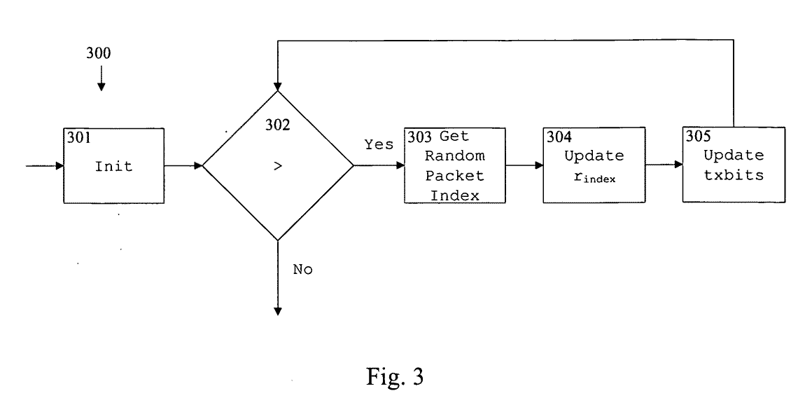

The baseline random (RND) method of enhancing quality of service is designed to spread the packet loss across multiple variable data rate (VDR) flows instead of limiting it to one VDR flow. This method bases its decision on which VDR network flows will suffer packet loss on a random number generator, pseudo random number generator, or a rotating counter. This method will continue to remove packets from the transmit list until the amount of information is less than the transmit threshold. This method is illustrated in FIG. 3. FIG. 3 illustrates circuit 300 baseline random decision criteria.

Circuit 300 consists of blocks 301, 302, 303, 304, and 305. Block 301 is an initialization block. In an embodiment, block 301 is implemented as Read Only Memory (ROM). In another embodiment, block 301 is implemented as computer software. In other embodiments, other methods may be used. Block 302 is a decision branch. In an embodiment, block 302 is implemented with multiplexors. In another embodiment, block 302 is implemented with conditional statements. In other embodiments, other methods may be used. Block 303 is for generating indices. In an embodiment, block 303 is implemented with a pseudo random number generator. In another embodiment, block 303 is implemented with a rotating counter. In other embodiments, other methods may be used. Block 304 is for updating the lengths. In an embodiment, block 304 is implemented with an addition unit. In another embodiment, block 304 is implemented with a subtraction unit. In other embodiments, other methods may be used. Block 305 is for updating total transmission bit counts. In an embodiment, block 305 is implemented with an addition unit. In another embodiment, block 305 is implemented with a subtraction unit. In other embodiments, other methods may be used.

Circuit 300, the baseline random (RND) decision criteria flow chart, is able to reduce the total units of data to transmit for the congested router model. It operates in an iterative fashion to generate an output number of units for transmission which is less than or equal to the link capacity. Due to the nature of the fair policy it will generate different outputs for the same inputs as not to unduly penalize an individual network flow. This decision flow can be either implement by adding flows to the set to transmit or by removing units from the set to transmit. Subtracting flows can be implemented using the following steps.
Step 1: Initialize the RND method.
   r′_{index}=rᵢ for all i from 1 to n
Step 2: if (total transmission units<=link capacity) exit
Step 3: Get a random packet index in range 1 to n.
Step 4: Drop r_{index}.
   r′_{index}=0
Step 5: Re-compute total transmission units.

$$Total transmission units = {\sum }_{i = 1}^{n} {r}_{i}^{′} .$$

Step 6: Go to Step 2.

The RND initialization step (1) requires computing the total transmission units that are required for transmitting all packets. The RND decision step (2) requires determining if the amount of information to transmit can be transmitted with the available link or if the current amount of information exceeds the link's capacity. This exits when the total amount of information to transmit is less than or equal to the link capacity. The RND selection step (3) chooses an index in the packets randomly and keeps track of which packets were chosen so that it does not choose the same packet more than once. This can be implemented by a random integer function. The RND drop step (4) drops the packet (sets its length to zero) specified by the index from RND step 3. The RND update step (5) re-computes the total transmission units with the updated packet length from the RND step 4. The RND loop step (6) loops back to the RND decision step 2 to determine if the total transmission count is less than or equal to the link capacity.

Alternatively, adding flows can be implemented using the following steps.
Step 1: Initialize the RND method.
   r′ᵢ=0 for all i from 1 to n
   listᵢ=0 for all i from 1 to n
Step 2: if (total transmission units>link capacity) or
   (all listᵢ's are maximized) exit
Step 3: Set list_{index}=r_{index} and get a new random packet index in range 1 to n.
Step 4: Add length of r_{index}.
   r′_{index}=r_{index}
Step 5: Re-compute total transmission units.

$$Total transmission units = {\sum }_{i = 1}^{n} {r}_{i}^{′} .$$

Step 6: Go to Step 2.

The RND initialization step (1) requires computing the total transmission units that are required for transmitting no packets. The RND decision step (2) requires determining if the current amount of information exceeds the link's capacity or if all packets have been maximized. This exits when the total amount of information to transmit exceeds the link capacity or all packets have been maximized. The RND selection step (3) saves the previous solution to listᵢ's and then chooses an index in the packets randomly. This keeps track of which packets were chosen so that it does not choose the same packet more than once. This can be implemented by a random integer function. The RND increase step (4) saves the previous lengths and increases the length of the packet specified by the index from RND step 3. The RND update step (5) re-computes the total transmission units with the updated packet lengths from the RND step 4. The RND loop step (6) loops back to the RND decision step 2 to determine if the total transmission count exceeds the link capacity. The solution for adding flows discards the last added index if the solution is larger than the capacity and returns the result in list.

The maximum number of iterations required for these algorithms is dependent on the number of information flows in the network (n). This will run n times. Therefore it has a runtime of O(n).

The router determines if the volume of information it must send is less than a threshold or not. If the volume of information is greater than the threshold then the router drops packets. FIG. 2 illustrates a diagram of the network router, packets (rᵢ's) at the router to transmit to multiple destinations over the congested node, and the threshold decision making process.

An example of the RND method is: Given VDR data of 250*x, where x in {1,2,3,4} with R1=1000, R2=500, R3=750, R4=250, and Threshold=2400.

This means that the node/router must randomly remove packets until the total bits to transmit is less than the threshold. Any set of three of these will lead to a result which is below the threshold.

If the threshold is reduced to 2000. Then the result will depend on which packet is chosen in the first round of random selection. Possible three packet solutions consist of {R2, R3, R4}, {R1, R3, R4} and {R1, R2, R4}. Possible two packet solutions consist of {R1, R2}, {R1, R3}, and {R2, R3} if R4 is removed in the first round.

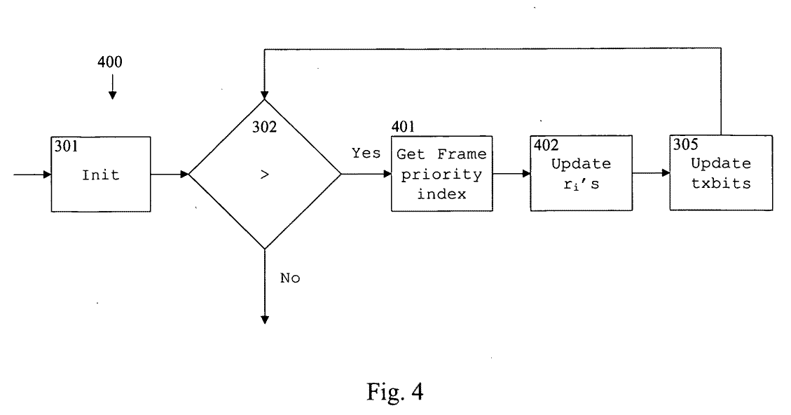

The frequency (FRQ) method of enhancing quality of service is designed to spread the packet loss across multiple variable data rate (VDR) flows instead of limiting it to one VDR flow. This method puts priority on the low frequency data for transmission which allows it to maintain high signal-to-noise ratio (SNR) and Mean Opinion Score (MOS) levels in the presence of moderately high network congestion at the network router level from FIG. 2. The FRQ method bases its decision on removing the less vital information in the variable data rate (VDR) flows. This less vital information can consist of higher frequency information for voice and other signals or it can consist of interleaved frames. This method will continue to remove data from the VDR flows until the amount of information is less than the transmit threshold. This method is illustrated in FIG. 4. FIG. 4 illustrates circuit 400 frequency decision criteria.

Circuit 400 consists of blocks 301, 302, 305, 401, and 402. Blocks 301, 302, and 305 are identical in functionality to circuit 300. Block 401 is for generating indices. In an embodiment, block 401 is implemented with a pseudo random number generator. In another embodiment, block 401 is implemented with a rotating counter. In other embodiments, other methods may be used. Block 402 is for updating the lengths. In an embodiment, block 402 is implemented with an addition unit. In another embodiment, block 402 is implemented with a subtraction unit. In other embodiments, other methods may be used.

Circuit 400, the frequency (FRQ) decision criteria flow chart, is able to reduce the total units of data to transmit for the congested router model. It operates in an iterative fashion to generate an output number of units for transmission which is less than or equal to the link capacity. Due to the nature of the fair policy it will generate different outputs for the same inputs as not to unduly penalize an individual network flow. This decision flow can be either implement by adding flows to the set to transmit or by removing units from the set to transmit. Subtracting flows can be implemented using the following steps.
Step 1: Initialize the FRQ method.
   r′ᵢ=rᵢ for all i from 1 to n
   p=frame priority index value=MAX_PRIORITY
Step 2: if (total transmission units<=link capacity) exit
Step 3: Set new frame priority index value.
   p=p−1
Step 4: Shrink length of packets r′ᵢ's for i from 1 to n to minimum of original priority level of rᵢ or p.
Step 5: Re-compute total transmission units.

$$Total transmission units = {\sum }_{i = 1}^{n} {r}_{i}^{′} .$$

Step 6: Go to Step 2.

The FRQ initialization step (1) requires computing the total transmission units that are required for transmitting all packets. The FRQ decision step (2) requires determining if the amount of information to transmit can be transmitted with the available link or if the current amount of information exceeds the link's capacity. This exits when the total amount of information to transmit is less than or equal to the link capacity. The FRQ selection step (3) chooses an index in the priority levels starting from the lowest priority and ending on the highest priority. This can be implemented by incrementing a counter. The FRQ shrink step (4) shrinks the length of all packets that contain data of the priority level specified by the index from FRQ step 3. The FRQ update step (5) re-computes the total transmission units with the updated packet lengths from the FRQ step 4. The FRQ loop step (6) loops back to the FRQ decision step 2 to determine if the total transmission count is less than or equal to the link capacity.

Alternatively, adding flows can be implemented using the following steps.
Step 1: Initialize the FRQ method.
   r′ᵢ=0 for all i from 1 to n
   p=frame priority index value=0
   listᵢ=0 for all i from 1 to n
Step 2: if (total transmission units>link capacity) or
   (all listᵢ's are maximized) exit
Step 3: Set listᵢ=rᵢ for i from 1 to n and set new frame priority index value.
   p=p+1
Step 4: Increase length of packets rᵢ's for i from 1 to n to minimum of original priority level of rᵢ or p.
Step 5: Re-compute total transmission units.

$$Total transmission units = {\sum }_{i = 1}^{n} {r}_{i}^{′} .$$

Step 6: Go to Step 2.

The FRQ initialization step (1) requires computing the total transmission units that are required for transmitting no packets. The FRQ decision step (2) requires determining if the current amount of information exceeds the link's capacity or if all packets have been maximized. This exits when the total amount of information to transmit exceeds the link capacity or all packets have been maximized. The FRQ selection step (3) saves the previous solution to listᵢ's and chooses an index in the priority levels starting from the lowest priority and ending on the highest priority. This can be implemented by incrementing a counter. The FRQ increase step (4) saves the previous lengths and increases the length of all packets that contain data of the priority level specified by the index from FRQ step 3. The FRQ update step (5) re-computes the total transmission units with the updated packet lengths from the FRQ step 4. The FRQ loop step (6) loops back to the FRQ decision step 2 to determine if the total transmission count exceeds the link capacity. The solution for adding flows discards the last added priority level if the solution is larger than the capacity and returns the result in list.

The maximum number of iterations required for these algorithms is dependent on the number of partitions for the variable rate data (p). Therefore it has a runtime of O(p).

The router determines if the volume of information it must send is less than a threshold or not. If the volume of information is greater than the threshold then the router drops bits from larger packets first. FIG. 2 illustrates a diagram of the network router, packets (rᵢ's) at the router to transmit to multiple destinations over the congested node, and the threshold decision making process.

An example of the FRQ method is: Given VDR data of 250*p, where p in {1,2,3,4} with R1=1000, R2=500, R3=750, R4=250, and Threshold=2400.

This means that the node/router must remove the higher frequency bits until the total bits to transmit is less than the threshold. In this case R1 is reduced to 750 when p is decreased to 3 and the total bits to transmit become less than the threshold which is 2250.

If the threshold is reduced to 2000. Then the FRQ policy further reduces R1 and R3 to become equal to the threshold when p is decreased to 2. Solution is {R1′=500, R2=500, R3′=500, R4=250}

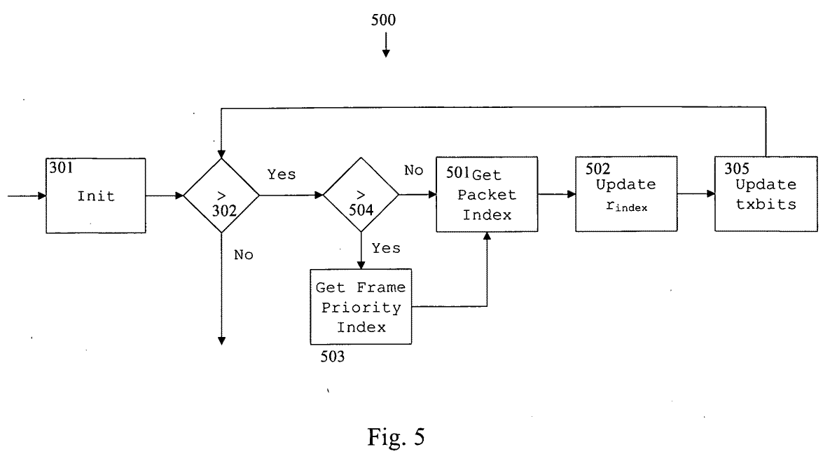

Another method is the combined random frequency (CRFRQ) policy. This method bases the decision on removal of the less vital information on a random number generator. This is able maximize QoS over multiple variable data rate (VDR) flows using the FRQ policy of dropping less vital information but without forcing all flows to be degraded to the same level. This method is illustrated in FIG. 5. FIG. 5 illustrates circuit 500 the CRFRQ decision criteria.

Circuit 500 consists of blocks 301, 302, 305, 501, 502, 503, and 504. Blocks 301, 302, and 305 are identical in functionality to those in circuit 300. Block 501 is for generating indices. In an embodiment, block 501 is implemented with a pseudo random number generator. In another embodiment, block 501 is implemented with a totaling counter. In other embodiments, other methods may be used. Block 502 is for updating the lengths. In an embodiment, block 502 is implemented with an addition unit. In another embodiment, block 502 is implemented with a subtraction unit. In other embodiments, other methods may be used. Block 503 is for generating a frame priority index. In an embodiment, block 503 is implemented with a counter. In another embodiment, block 503 is implemented with a shifter. In other embodiments, other methods may be used. Block 504 is a decision branch. In an embodiment, block 504 is implemented with multiplexors. In another embodiment, block 504 is implemented with conditional statements. In other embodiments, other methods may be used.

Circuit 500, the combined random FRQ (CRFRQ) decision criteria flow chart, is able to reduce the total units of data to transmit for the congested router model. It operates in an iterative fashion to generate an output number of units for transmission which is less than or equal to the link capacity. Due to the nature of the fair policy it will generate different outputs for the same inputs as not to unduly penalize an individual network flow. This decision flow can be either implement by adding flows to the set to transmit or by removing units from the set to transmit. Subtracting flows can be implemented using the following steps.
Step 1: Initialize the CRFRQ method.
   r′ᵢ=rᵢ for all i from 1 to n
   p=frame priority index=MAX_PRIORITY
Step 2: if (total transmission units<=link capacity) exit
Step 3: Get a random packet index in range 1 to n.
   if (all indices have been chosen for this frame priority level) Set p=p−1
Step 4: Shrink length of r′_{index} to minimum of original frame priority level of r_{index} or p.
Step 5: Re-compute total transmission units.

$$Total transmission units = {\sum }_{i = 1}^{n} {r}_{i}^{′} .$$

Step 6: Go to Step 2.

The CRFRQ initialization step (1) requires computing the total transmission units that are required for transmitting all packets. The CRFRQ decision step (2) requires determining if the amount of information to transmit can be transmitted with the available link or if the current amount of information exceeds the link's capacity. This exits when the total amount of information to transmit is less than or equal to the link capacity. The CRFRQ selection step (3) chooses an index in the packets randomly for each priority level starting from the lowest priority and ending on the highest priority. For each priority level a packet may be chosen only once. This can be implemented by incrementing a counter and using a random integer function. The CRFRQ shrink step (4) shrinks the length of the packet specified by the index from CRFRQ step 3 by the length of the data corresponding to the current priority level. The CRFRQ update step (5) re-computes the total transmission units with the updated packet lengths from the CRFRQ step 4. The CRFRQ loop step (6) loops back to the CRFRQ decision step 2 to determine if the total transmission count is less than or equal to the link capacity.

Alternatively, adding flows can be implemented using the following steps.
Step 1: Initialize the CRFRQ method.
   r′ᵢ=0 for all i from 1 to n
   p=frame priority index=0
   listᵢ=0 for all i from 1 to n; index=0
Step 2: if (total transmission units>link capacity) or
   (all listᵢ's are maximized) exit
Step 3: Set list_{index}=r′_{index} and get a random packet index in range 1 to n.
   if (all indices have been chosen for this frame priority level) Set p=p+1
Step 4: Increase length of r′_{index} to minimum of original frame priority level of r_{index} or p.
Step 5: Re-compute total transmission units.

$$Total transmission units = {\sum }_{i = 1}^{n} {r}_{i}^{′} .$$

Step 6: Go to Step 2.

The CRFRQ initialization step (1) requires computing the total transmission units that are required for transmitting no packets. The CRFRQ decision step (2) requires determining if the current amount of information exceeds the link's capacity or if all packets have been maximized. This exits when the total amount of information to transmit exceeds the link capacity or all packets have been maximized. The CRFRQ selection step (3) chooses an index in the packets randomly for each priority level starting from the highest priority and ending on the lowest priority. For each priority level a packet may be chosen only once. This can be implemented by incrementing a counter and using a random integer function. The CRFRQ increase step (4) saves the previous lengths and increases the length of the packet specified by the index from CRFRQ step 3 by the length of the data corresponding to the current priority level. The CRFRQ update step (5) re-computes the total transmission units with the updated packet length from the CRFRQ step 4. The CRFRQ loop step (6) loops back to the CRFRQ decision step 2 to determine if the total transmission count exceeds the link capacity. The solution for adding flows discards the last added index if the solution is larger than the capacity and returns the results in list.

The maximum number of iterations required for these algorithms is dependent on the number of information flows in the network (n) and the number of partitions for the variable rate data (p). Therefore it has a runtime of O(n*p).

An example of this method is: Given VDR data of 250″p, where p in {1,2,3,4} with R1=1000, R2=500, R3=750, R4=250, and Threshold=2400.

This means that the node/router must remove the higher frequency bits until the total bits to transmit is less than the threshold. In this case R1 is reduced to 750 when p is decreased to 3 and the total bits to transmit become less than the threshold which is 2250.

If the threshold is reduced to 2000. Then the CRFRQ policy must randomly choose between R1 and R3 when p is decreased to 2 to reduce to become equal to the threshold.

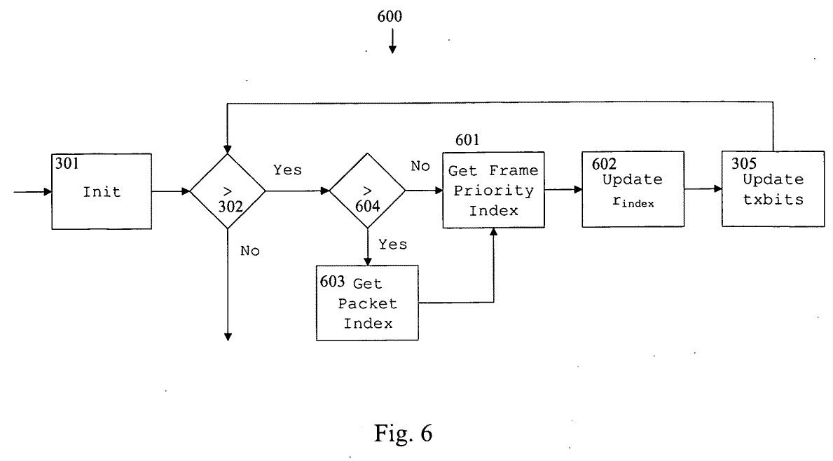

Another method is the combined frequency random (CFRND) policy. This method bases the decision on randomly selecting all or some of the packets. This method is illustrated in FIG. 6. FIG. 6 illustrates circuit 600 the CFRND decision criteria.

Circuit 600 consists of blocks 301, 302, 305, 601, 602, 603 and 604. Blocks 301, 302, and 305 are identical in functionality to those in circuit 300. Block 601 is for generating packet indices. In an embodiment, block 601 is implemented with a pseudo random number generator. In another embodiment, block 601 is implemented with a rotating counter. In other embodiments, other methods may be used. Block 602 is for updating the lengths. In an embodiment, block 602 is implemented with an addition unit. In another embodiment, block 602 is implemented with a subtraction unit. In other embodiments, other methods may be used. Block 603 is for generating a packet index. In an embodiment, block 603 is implemented with a pseudo random number generator. In another embodiment, block 603 is implemented with a counter. In other embodiments, other methods may be used. Block 604 is a decision branch. In an embodiment, block 604 is implemented with multiplexors. In another embodiment, block 604 is implemented with conditional statements. In other embodiments, other methods may be used.

Circuit 600, the combined frequency random (CFRND) decision criteria flow chart, is able to reduce the total units of data to transmit for the congested router model. It operates in an iterative fashion to generate an output number of units for transmission which is less than or equal to the link capacity. This method is not intended to be fair but it improves upon the basic RND method by allowing partial packets to be transmitted instead of forcing a complete drop of the packet. In this way, the CFRND method maximizes its use of congested links. This decision flow can be either implemented by adding units to the set to transmit or by removing units from the set to transmit. Subtracting units can be implemented using the following steps.
Step 1: Initialize the CFRND method.
   r′ᵢ=rᵢ for all i from 1 to n
   p=frame priority index=MAX_PRIORITY
   index=random packet index
Step 2: if (total transmission units<=link capacity) exit
Step 3: Get priority (range 1 top) of packet index.
   if (p) Set p=p−1
   Else get new random packet index in range 1 to n
Step 4: Shrink length of r′_{index} to minimum of original frame priority level of r_{index} or p.
Step 5: Re-compute total transmission units.

$$Total transmission units = {\sum }_{i = 1}^{n} {r}_{i}^{′} .$$

Step 6: Go to Step 2.

The CFRND initialization step (1) requires computing the total transmission units that are required for transmitting all packets. The CFRND decision step (2) requires determining if the amount of information to transmit can be transmitted with the available link or if the current amount of information exceeds the link's capacity. This exits when the total amount of information to transmit is less than or equal to the link capacity. The CFRND selection step (3) gets the priority of the packet indexed by the index value and decreases its priority level. If the priority of the packet indexed by the index value is 0 then it generates a new random packet index value. The CFRND shrink step (4) shrinks the length of the packet specified by the index from CFRND step 3 by the length of the data corresponding to the current priority level. The CFRND update step (5) re-computes the total transmission units with the updated packet lengths from the CFRND step 4. The CFRND loop step (6) loops back to the CFRND decision step 2 to determine if the total transmission count is less than or equal to the link capacity.

Alternatively, adding flows can be implemented using the following steps.
Step 1: Initialize the CFRND method.
   r′ᵢ=0 for all i from 1 to n
   p=priority index=0
   index=random packet index
   listᵢ=0 for all i from 1 to n
Step 2: if (total transmission units>link capacity) or
   (all listᵢ's are maximized) exit
Step 3: Set list_{index}=r′_{index} and get priority (range 1 to p) of packet index.
   if (p<max priority of packet r_{index}) Set p=p+1
   Else get new random packet index in range 1 to n
Step 4: Increase length of r′_{index} to minimum of original priority level of r_{index} or p.
Step 5: Re-compute total transmission units.

$$Total transmission units = {\sum }_{i = 1}^{n} {r}_{i}^{′} .$$

Step 6: Go to Step 2.

The CFRND initialization step (1) requires computing the total transmission units that are required for transmitting no packets. The CFRND decision step (2) requires determining if the current amount of information exceeds the link's capacity or if all packets have been maximized. This exits when the total amount of information to transmit exceeds the link capacity or all packets have been maximized. The CFRND selection step (3) gets the priority of the packet indexed by the index value and increases its priority level. If the priority of the packet indexed by the index value is the maximum of the priority of the r_{index} packet then it generates a new random packet index value. The CFRND increase step (4) saves the previous lengths and increases the length of the packet specified by the index from CFRND step 3 by the length of the data corresponding to the current priority level. The CFRND update step (5) re-computes the total transmission units with the updated packet length from the CFRND step 4. The CFRND loop step (6) loops back to the CFRND decision step 2 to determine if the total transmission count exceeds the link capacity. The solution for adding flows discards the last added index if the solution is larger than the capacity and returns the results in list.

The maximum number of iterations required for these algorithms is dependent on the number of information flows in the network (n) and the number of partitions for the variable rate data (p). Therefore it has a runtime of O(n*p).

An example of this method is: Given VDR data of 250*p, where p in {1,2,3,4} with R1=1000, R2=500, R3=750, R4=250, and Threshold=2400.

This means that the node/router must select a random packet to remove some or all the frequency bits until the total bits to transmit is less than the threshold. In an example the CFRND method randomly selects R4 first. Then this method drops 250. The total is 2250 which is below the threshold. Other possible solutions are (750, 500, 750, 250), (1000, 250, 750, 250), and (1000, 500, 500, 250).

If the threshold is reduced to 2000. Then the CFRND policy may have to randomly choose more than one packet to drop data from. If R4 is selected first. Then this method drops 250. The total 2250 is above the threshold and CFRND must select another packet to drop data from. If R4 is selected first then possible solutions are (750, 500, 750, 0), (1000, 250, 750, 0), and (1000, 500, 500, 0). If R4 is not selected first then possible solutions are (500, 500, 750, 250), (1000, 0, 750, 250), and (1000, 500, 250, 250).

The next method is a variant to the CRFRQ method called variant random frequency (VRF) method. This method allows flows to have a higher standard deviation in priority values than the previous method during congested times because it does not enforce that all flows be reduced down to lower priorities during congestion.

Circuit 700 consists of blocks 301, 302, 305, 701, 702, 703, and 704. Blocks 301, 302, and 305 are identical in functionality to those in circuit 300. Block 701 is for generating packet indices. In an embodiment, block 701 is implemented with a pseudo random number generator. In another embodiment, block 701 is implemented with a rotating counter. In other embodiments, other methods may be used. Block 702 is for updating the lengths. In an embodiment, block 702 is implemented with an addition unit. In another embodiment, block 702 is implemented with a subtraction unit. In other embodiments, other methods may be used. Blocks 703 and 704 represent a simplified structure of the VRF decision criteria flow chart. Block 703, circle A, is for generating packet indices. In an embodiment, block 703 is implemented with a pseudo random number generator. In another embodiment, block 703 is implemented with a rotating counter. In other embodiments, other methods may be used. Block 704, circle B, is updating the priority index values. In an embodiment, block 704 is implemented with an addition unit. In another embodiment, block 704 is implemented with a subtraction unit. In other embodiments, other methods may be used.

Circuit 700, the variant random frequency (VRF) decision criteria flow chart, is able to reduce the total units of data to transmit for the congested router model. It operates in an iterative fashion to generate an output number of units for transmission which is less than or equal to the link capacity. This method is not intended to be fair because it randomly chooses packets and updates its priority value with disregard for other packets priority values but it improves upon the basic RND method by allowing partial packets to be transmitted instead of forcing a complete drop of the packet. In this way, the VRF method maximizes its use of congested links but does not guarantee a basic delivery level for any channel during congestion. Subtracting flows can be implemented using the following steps.
Step 1: Initialize the VRF method.
   r′ᵢ=rᵢ for all i from 1 to n
Step 2: if (total transmission units<=link capacity) exit
Step 3: Get a random packet index in range 1 to n.
Step 4: Shrink length of r′_{index}.
   Decrease frame priority level value for r′_{index} and remove data corresponding to the higher frame priority value
Step 5: Re-compute total transmission units.

$$Total transmission units = {\sum }_{i = 1}^{n} {r}_{i}^{′} .$$

Step 6: Go to Step 2.

The VRF initialization step (1) requires computing the total transmission units that are required for transmitting all packets. The VRF decision step (2) requires determining if the amount of information to transmit can be transmitted with the available link or if the current amount of information exceeds the link's capacity. This exits when the total amount of information to transmit is less than or equal to the link capacity. The VRF selection step (3) chooses an index in the packets randomly. The VRF shrink step (4) shrinks the length of the packet specified by the index from VRF step 3 by the length of the data corresponding to decreasing the current priority level by one. The VRF update step (5) re-computes the total transmission units with the updated packet lengths from the VRF step 4. The VRF loop step (6) loops back to the VRF decision step 2 to determine if the total transmission count is less than or equal to the link capacity.

Alternatively, adding flows can be implemented using the following steps.
Step 1: Initialize the VRF method.
   r′ᵢ=0 for all i from 1 to n
   p=frame priority index=0
   listᵢ=0 for all i from 1 to n; index=0
Step 2: if (total transmission units>link capacity) or
   (all listᵢ's are maximized) exit
   Step 3: Set list_{index}=r′_{index} and get a random packet index in range 1 to n.

Increase frame priority level value for r′_{index} and add data corresponding to the increased frame priority value.
Step 4: Increase length of r′_{index} to minimum of original frame priority index of r_{index} or p.
Step 5: Re-compute total transmission units.

$$Total transmission units = {\sum }_{i = 1}^{n} {r}_{i}^{′} .$$

Step 6: Go to Step 2.

The VRF initialization step (1) requires computing the total transmission units that are required for transmitting no packets. The VRF decision step (2) requires determining if the current amount of information exceeds the link's capacity or if all packets have been maximized. This exits when the total amount of information to transmit exceeds the link capacity or all packets have been maximized. The VRF selection step (3) chooses an index in the packets randomly. The VRF increase step (4) saves the previous lengths and increases the length of the packet specified by the index from VRF step 3 by the length of the data corresponding to increasing the current priority level by one. The VRF update step (5) re-computes the total transmission units with the updated packet length from the VRF step 4. The VRF loop step (6) loops back to the VRF decision step 2 to determine if the total transmission count exceeds the link capacity. The solution for adding flows discards the last added index if the solution is larger than the capacity and returns the results in list.

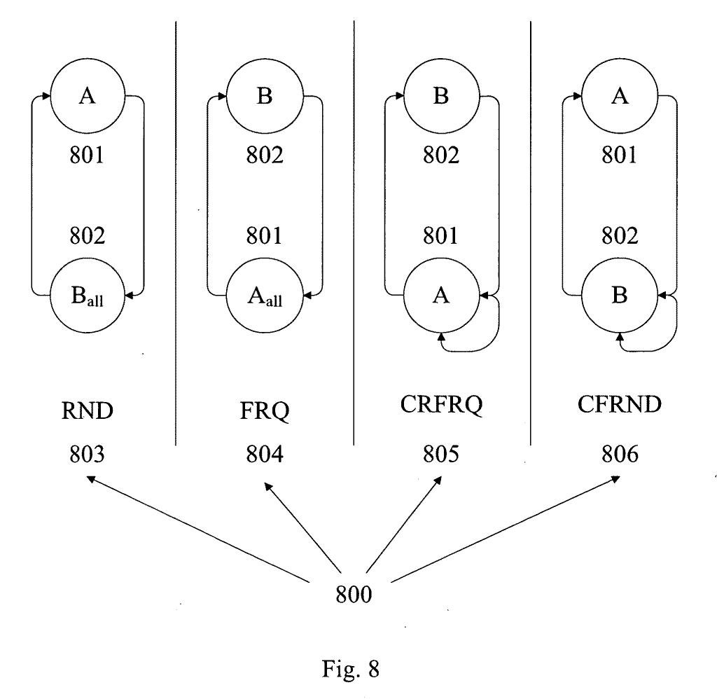

The main idea behind the four policies (RND, FRQ, CRFRQ, and CFRND) is to loop over either packet indices and to loop over priority levels. The main differences between these methods are 1) which loop is the outer loop and which loop is the inner loop, and 2) how the indices are chosen in each loop. The RND method chooses priority levels all at once. The FRQ method chooses packet indices all at once. The CRFRQ method chooses a priority level first then randomly chooses packet indices once per priority level. After choosing all packet indices it chooses a new priority level. The CFRND method chooses a packet index first then chooses a priority level once per index. After all priority levels have been chosen, it chooses a new packet index. FIG. 8 illustrates this simplified description of these four policies (RND, FRQ, CRFRQ, and CFRND).

Circuit 800 consists of blocks 801, 802, 803, 804, 805, and 806. Block 801 implements a loop that occurs over packet indices. In an embodiment, block 801 is implemented with a for loop. In another embodiment, block 801 is implemented with a counter and comparator. In other embodiments, other methods may be used. Block 802 implements a loop that occurs over priority values. In an embodiment, block 802 is implemented with a for loop. In another embodiment, block 802 is implemented with a counter and comparator. In other embodiments, other methods may be used. Block 803 is the RND circuit. Block 804 is the FRQ circuit. Block 805 is the CRFRQ circuit. Block 806 is the CFRND circuit.

Circuit 800 consists of four separate circuits. The first circuit labeled RND operates as follows. The RND method selects a packet index randomly (circle A, block 801). Then the RND method chooses priority levels all at once in (circle B, block 802). The RND method will update the total packets to transmit value and check if it has found a solution. If it has not, then it returns to (circle A, block 801) and chooses a new packet index. The FRQ method selects a priority level (circle B, block 802) first. Then the FRQ method chooses packet indices all at once in (circle A, block 801). The FRQ method will update the total packets to transmit value and check if it has found a solution. If it has not, then it returns to (circle B, block 802) and chooses a new priority value. The CRFRQ method selects a priority level (circle B, block 802) first. Then the CRFRQ method chooses packet index in (circle A, block 801). The CRFRQ method will update the total packets to transmit value and check if it has found a solution. If it has not, then it returns to either block 801 (circle A) or block 802 (circle B). If all packets have been chosen for the current priority level the CRFRQ method will return to block 802 (circle B). If not it will return to block 801 (circle A) choose a new packet index. The CRFRQ method will update the total packets to transmit value and check if it has found a solution. The CFRND method selects a packet index (circle A, block 801) first. Then the CFRND method chooses priority value (circle B, block 802). The CFRND method will update the total packets to transmit value and check if it has found a solution. If it has not, then it returns to either block 801 (circle A) or block 802 (circle B). If all priority values have been chosen for the current packet index the CFRND method will return to block 801 (circle A). If not it will return to block 802 (circle B) to choose a new priority value. The CFRND method will update the total packets to transmit value and check if it has found a solution.

Variable rate network congestion control requires setting priority values for different data. Depending on the data there are multiple methods for setting priority values which are compatible with the previously described methods for implementing variable rate network congestion control. Variable rate digital audio representation consists of data which is highly important and data which is less important but enhances quality. The two main examples for variable rate digital audio representation are based on variable rate voice encoders and multi-frame packets with receiver side packet loss concealment (PLC). In other examples, other methods for determining priorities may be used.

Variable rate encoders separate the speech into high priority low frequency data and lower priority high frequency data. The high frequency data enhances the quality of the speech reconstruction. The low frequency data plays a significant role in achieving acceptable Mean Opinion Score (MOS) values and high Signal-to-Noise ratio (SNR). Without the low frequency data, it is typically impossible to reconstruct intelligible speech. FIG. 6 illustrates circuit 600 setting variable rate data priorities method.

Circuit 900 consists of blocks 901, 902, 903, 904, 905, 906, 907 and 908. Block 901 represents an input device of a signal. In an embodiment, block 901 is implemented with a microphone and a sound recording device. In another embodiment, block 901 is implemented with an analog to digital converter. In other embodiments, other methods may be used. Block 902 is a variable rate signal encoder. In an embodiment, block 902 is implemented with a voice encoder. In another embodiment, block 902 is implemented with a fast Fourier transform. In other embodiments, other methods may be used. Block 903 represents the output bus of block 902. In an embodiment, block 903 is implemented with wires. In another embodiment, block 903 is implemented with a switch matrix. In other embodiments, other methods may be used. Block 904 is the output of the block 902. Block 905 is the low priority data in block 904. Block 906 is the lowest medium priority data in block 904. Block 907 is the highest medium priority data in block 904. Block 908 is the high priority data in block 904. In an embodiment, block 904 consists of data categorized with blocks 905 and 908 only. In another embodiment, block 904 consists of data categorized with blocks 905, 907, and 908 only. In another embodiment, block 904 consists of data categorized with blocks 905, 906, 907, and 908 only. In other embodiments, block 904 consists of data categorized with more blocks than what is illustrated in circuit 900. In other embodiments, other methods may be used.

Circuit 900 operates by taking input from block 901 and transforming it with block 902 into a new form shown by block 904. This method generates a new form in block 904 which consists of, data with variable priority levels. These levels can be used by the FRQ, CRFRQ, CFRND, and VRF methods for network congestion control.

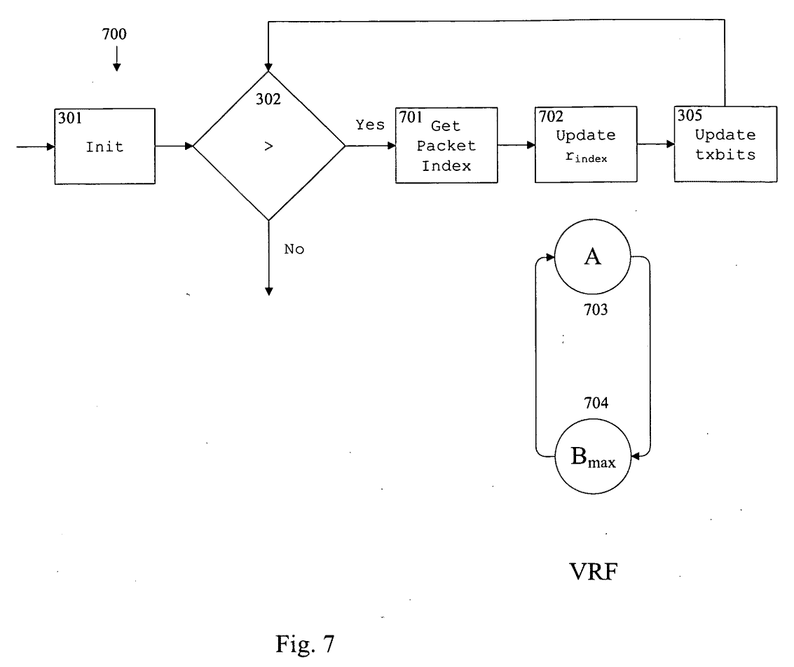

Multi-frame packets with packet loss concealment (PLC) for speech reconstruction on the receiver side separate the individual frames into high priority and low priority based on their position in the speech with the goal of minimizing the length of the gaps. The high priority data are the frames which are farthest apart in the same packet and between packets. FIG. 7 illustrates circuit 700 frame reordering for variable rate congestion control for an example multi-frame packet consisting of 16 frames.

Circuit 1000 consists of blocks 1001, 1002, and 1003. Block 1001 consists of the original frame indices for the multi-frame packet. In an embodiment, block 1001 is implemented as random access memory (RAM). In other embodiments, other methods may be used. Block 1002 reorders the indices for the packet to support variable rate congestion control. In an embodiment, block 1002 is implemented with a switch matrix. In another embodiment, block 1002 is implemented with multiplexors. In other embodiments, other methods may be used. Block 1003 is the indices for the reordered frames based on their original position in the multi-frame packet. The highest priority frames are on the left with decreasing priority from left to right. Finally, the lowest priority frame is on the right. In an embodiment, block 1003 is implemented as random access memory (RAM). In other embodiments, other methods may be used.

Circuit 1000 operates by taking the original indices for the frames (block 1001) in the multi-frame packet and shuffling them with block 1002 in a specific way to ensure that the highest priority frames are on the left and that the priority values decrease from left to right with the lowest priority frame on the right. The final order is shown in block 1003.

The reorder operation (block 1002) is a sort operation based on priority values for individual frames. In an embodiment, the priority values can be constants. This requires O(1) time to reorder the frames. In another embodiment, the priority values can vary. This requires O(n*log(n)) time to reorder the frames using fast sort algorithms. It may require O(n²) time to reorder the frames if using less efficient sort operations.

The new index locations (1003) in circuit 1000 are computed by generating the bit reversal of the original index (1001). The total number of bits used to represent the bit index is defined as log₂(<total frames per packet>). In circuit 1000 the total frames per packet is 16 and the log base 2 of 16 is 4. Therefore, the bit representation of the indices uses 4 bits. The reorder process performed by block 1002 is called bit-reversal because it reverses the order of the bits such that the old most significant bit (MSB) in the bit representation is reversed and becomes the new least significant bit (LSB) and the old LSB becomes the new MSB. This process continues until the MSBs have been swapped with the LSBs. A bit-reversal of index 1=0001 becomes index 8=1000. A bit-reversal of index 3=0011 becomes index 12=1100.

The FRQ, CRFRQ, CFRND, and VRF network congestion methods take the variable priorities into account when determining which data to transmit during highly congested times and which data can be dropped. The RND network congestion method does not make use of variable priorities in packets but can use the variable priorities in RND Step 4 when getting an index into the packets to achieve better Quality of Service (QoS). An astute reader will notice that this modification to the RND method has been presented as the CFRND method.

Several approaches have been presented above to reduce congestion in packet networks. Other types of decongestion approaches that can benefit from the invention will become apparent to persons skilled in the relevant arts given the description herein. It will be understood by those skilled in the relevant art that various changes in form and details of the embodiments described above may be made without departing from the spirit and scope of the present invention as defined in the claims. Thus, the breadth and scope of the present invention should not be limited by any of the above-described exemplary embodiments, but should be defined only in accordance with the following claims and their equivalents.

What is claimed is:

1. A network decongestion router with variable data-rate packets from N (N>=1 and an integer) sources as inputs comprising:
a comparison of available output flow rate and input flow rate of the router,
outputting of all variable data-rate packets if the output flow rate is greater than or equal to the input flow rate,
otherwise, assigning indexes 1 to M (where M>=1 and is an integer) for all M packets at the input of the router;
assigning non-negative integer priority labels 1 to P_i corresponding to frames of packet i, where i ranges from 1 to M, and let P_Max be the maximum of all the highest priority labels of all packets;
repeat for each packet index from 1 to M incrementing by 1 at each step;
and repeat for each index priority label from P_Max to 1 decrementing by 1 at each step;
drop data of the frame corresponding to current priority label of current packet until the output flow rate is greater than or equal to the modified flow rate updated after deleting data from the selected frame

2. A network decongestion router with variable data-rate packets from N (N>=1 and an integer) sources as inputs comprising:
a comparison of available output flow rate and input flow rate of the router,
outputting of all variable data-rate packets if the output flow rate is greater than or equal to the input flow rate,
otherwise, assigning indexes 1 to M (where M>=1 and is an integer) for all M packets at the input of the router;
assigning non-negative integer priority labels 1 to P_i corresponding to frames of packet i, where i ranges from 1 to M, and let P_Max be the maximum of all the highest priority labels of all packets;
start with an empty list of packets to be outputted;
repeat for each packet index from 1 to M incrementing index by 1 at each step;
repeat for each priority label from 1 to P_Max incrementing by 1 at each step;
add data of the frame corresponding to current priority label of current packet number as long as the output flow rate is greater than or equal to the modified flow rate updated after adding data from the selected frame

3. A network decongestion router with variable data-rate packets from N (N>=1 and an integer) sources as inputs comprising:
a comparison of available output flow rate and input flow rate of the router,
outputting of all variable data-rate packets if the output flow rate is greater than or equal to the input flow rate,
otherwise, assign indexes 1 to M (where M>=1 and is an integer) for all M packets at the input of the router;
assigning non-negative integer priority labels 1 to P_i corresponding to frames of packet i, where i ranges from 1 to M, and let P_Max be the maximum of all the highest priority labels of all packets, where data of a lower priority label frame is more important than a higher priority label frame;
repeat for each index priority label from P_Max to 1 decrementing by 1 at each step;
and repeat for each packet index from 1 to M incrementing by 1 at each step;
drop data of the frame corresponding to current priority label of current packet until the output flow rate is greater than or equal to the modified flow rate updated after deleting data from the selected frame

4. A network decongestion router with variable data-rate packets from N (N>=1 and an integer) sources as inputs comprising:
a comparison of available output flow rate and input flow rate of the router,
outputting of all variable data-rate packets if the output flow rate is greater than or equal to the input flow rate,
otherwise, assigning indexes 1 to M (where M>=1 and is an integer) for all M packets at the input of the router;
assigning non-negative integer priority labels 1 to P_i corresponding to frames of packet i, where i ranges from 1 to M, and let P_Max be the maximum of all the highest priority labels of all packets;
start with an empty list of packets to be outputted;
repeat for each priority label from 1 to P_Max incrementing by 1 at each step;
and repeat for each packet index from 1 to M incrementing index by 1 at each step;
add data of the frame corresponding to current priority label of current packet number as long as the output flow rate is greater than or equal to the modified flow rate updated after adding data from the selected frame

5. A network decongestion router with variable data-rate packets from N (N>=1 and an integer) sources as inputs comprising:
a comparison of available output flow rate and input flow rate of the router,
outputting of all variable data-rate packets if the output flow rate is greater than or equal to the input flow rate,
otherwise, assigning indexes 1 to M (where M>=1 and is an integer) for all M packets at the input of the router;
assigning non-negative integer priority labels 1 to P_i corresponding to frames of packet i, where i ranges from 1 to M, and let P_Max be the maximum of all the highest priority labels of all packets;
repeat until the output flow rate is greater than or equal to the modified flow rate updated after deleting data from the selected frame:
Get a random packet index
drop data of the frame corresponding to the highest frame priority index of current packet and reduce its highest priority index by one,

6. A network decongestion router with variable data-rate packets from N (N>=1 and an integer) sources as inputs comprising:
a comparison of available output flow rate and input flow rate of the router,
outputting of all variable data-rate packets if the output flow rate is greater than or equal to the input flow rate,
otherwise, assigning indexes 1 to M (where M>=1 and is an integer) for all M packets at the input of the router;
assigning non-negative integer priority labels 1 to P_i corresponding to frames of packet i, where i ranges from 1 to M, and let P_Max be the maximum of all the highest priority labels of all packets;
start with an empty list of packets to be outputted;
repeat until the output flow rate is greater than or equal to the modified flow rate updated after adding data from the selected frame:
Get a random packet index
Increase its current frame priority index by one add data of the frame corresponding to the new current frame priority index

7. The router of claims 1-6 where the packet index is chosen at random

8. The router of claims 1-6 where the packet index is assigned by fixed priorities

9. The router of claims 1-6 where the priority index of a frame in a packet is chosen by fixed priorities

10. The router of claims 1-6 where the router is part of an internet network

11. The router of claims 1-6 where the router is part of a packet network

12. The router of claim 1 where all frames of a selected packet are dropped simultaneously

13. The router of claim 2 where all frames of a selected packet are added simultaneously

14. The router of claim 3 where frames of all packet indices of selected frame priority index are dropped simultaneously

15. The router of claim 4 where frames of all packet indices of selected frame priority index are added simultaneously

16. A network router to process the input frames of a packet from a certain source and order the frame numbers in an increasing manner using an unsigned binary integer representation, and reorder them in an increasing order with respect to the bit-reversed frame numbers

17. A transmitter to process the input frames of a packet and order the frame numbers in an increasing manner using an unsigned binary integer representation, and output them in a reordered manner with frame numbers in an increasing order with respect to the bit-reversed frame numbers

18. The router in claims 16-17 where the router is part of a packet network

19. The router in claims 16-17 where the data may represent a speech signal

20. The router in claim 16-17 where the data may represent an image signal.
